(19) United States
(12) Patent Application Publication
(10) Pub. No.: US 2010/0302822 A1
(43) Pub. Date: Dec. 2, 2010

(54) Flyback Power converters

(75) Inventors: Zhao WANG, Beijing (CN); Xianhui Dong, Beijing (CN); Zhe Yang, Beijing (CN); Xiaodong Yang, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 12/788,959

(22) Filed: May 27, 2010

(30) Foreign Application Priority Data
May 27, 2009 (CN) 200910085315.X

(51) Int. Cl. H02M 7/06

(52) U.S. Cl. 363/126

(57) ABSTRACT

Designs of flyback power converters are described. According to one aspect of the designs, a power converter includes a primary side including a primary winding of a transformer coupled to an input voltage and a primary switch for switching on or off the primary winding, a secondary side including a secondary winding of the transformer for generating an output voltage, and a loop controller configured to sample a feedback voltage representative of the output voltage, generate a gate signal with a fixed falling edge and an adjustable rising edge to drive the primary switch, and adjust a duty cycle of the gate signal by adjusting the rising edge of the gate signal until the feedback voltage converges to a reference voltage.

### BACKGROUND OF THE INVENTION

1. Field of the Invention

The present invention relates to an area of power supply, and more particularly related to flyback power converters.

2. Description of Related Art

A flyback power converter is widely used in AC-DC converters and DC-DC converters. A flyback power converter comprises a primary side and a secondary side. In order to satisfy a safety standard and avoid electric shocks at the secondary side in exceptional situations, the primary side is isolated from the secondary side usually. Depending one implementation, an auxiliary stage is employed by the flyback power converter to sample a voltage of the secondary side approximately for complete isolation.

The primary side comprises a primary switch droved by a gate signal to control energy storage of the primary side. A feedback voltage is sampled only after the primary switch is switched off because of characteristics of the flyback power converter having the auxiliary stage. The sampled feedback voltage is updated to generate a new duty cycle of the primary switch after the primary switch is switched off each time. The new duty cycle of the primary switch is used to determine an off time of the primary switch in a next cycle. In other words, the new duty cycle generated in the current cycle becomes effective in the next cycle. Thereby, it requires almost one cycle delay to update the duty cycle in the prior art.

The delay accumulated in plural cycles may result in a larger overshoot or a larger undershoot of an output voltage of the flyback power converter and a slower loop transient response.

Thus, improved techniques for a flyback power converter are desired to overcome the above disadvantages.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention is related to flyback power converters. According to one aspect of the designs, a power converter includes a primary side including a primary winding of a transformer coupled to an input voltage and a primary switch for switching on or off the primary winding, a secondary side including a secondary winding of the transformer for generating an output voltage, and a loop controller configured to sample a feedback voltage representative of the output voltage, generate a gate signal with a fixed falling edge and an adjustable rising edge to drive the primary switch, and adjust a duty cycle of the gate signal by adjusting the rising edge of the gate signal until the feedback voltage converges to a reference voltage.

One of the features, benefits and advantages in the present invention is to minimize delays accumulated in cycles that may result in a larger overshoot or a larger undershoot of an output voltage of a flyback power converter and a slower loop transient response.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a circuit diagram schematically showing an exemplary flyback power converter according to one embodiment of the present invention;

FIG. 2 is a circuit diagram schematically showing an exemplary loop controller shown in FIG. 1;

FIG. 3 schematically shows waveforms of signals of the flyback power converter shown in FIG. 1;

FIG. 4 schematically shows waveforms of signals of a conventional flyback power converter;

FIG. 5 is a schematic comparison diagram of a loop transient response of the conventional flyback power converter and a loop transient response of the flyback power converter in the present invention;

FIG. 6 is a block diagram showing an exemplary current sampling circuit according to one embodiment of the present invention;

FIG. 7 is a circuit diagram showing an exemplary voltage sampling circuit according to one embodiment of the present invention;

FIG. 8 is a circuit diagram showing an exemplary current detection circuit according to one embodiment of the present invention;

FIG. 9 is a circuit diagram showing an exemplary voltage-current converter according to one embodiment of the present invention;

FIG. 10 is a circuit diagram showing an exemplary oscillator circuit according to one embodiment of the present invention;

FIG. 11 is a circuit diagram showing another exemplary circuit generating a second clock signal CLK2 according to one embodiment of the present invention; and

FIG. 12 is a circuit diagram showing another exemplary current sampling circuit according to one embodiment of the present invention.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

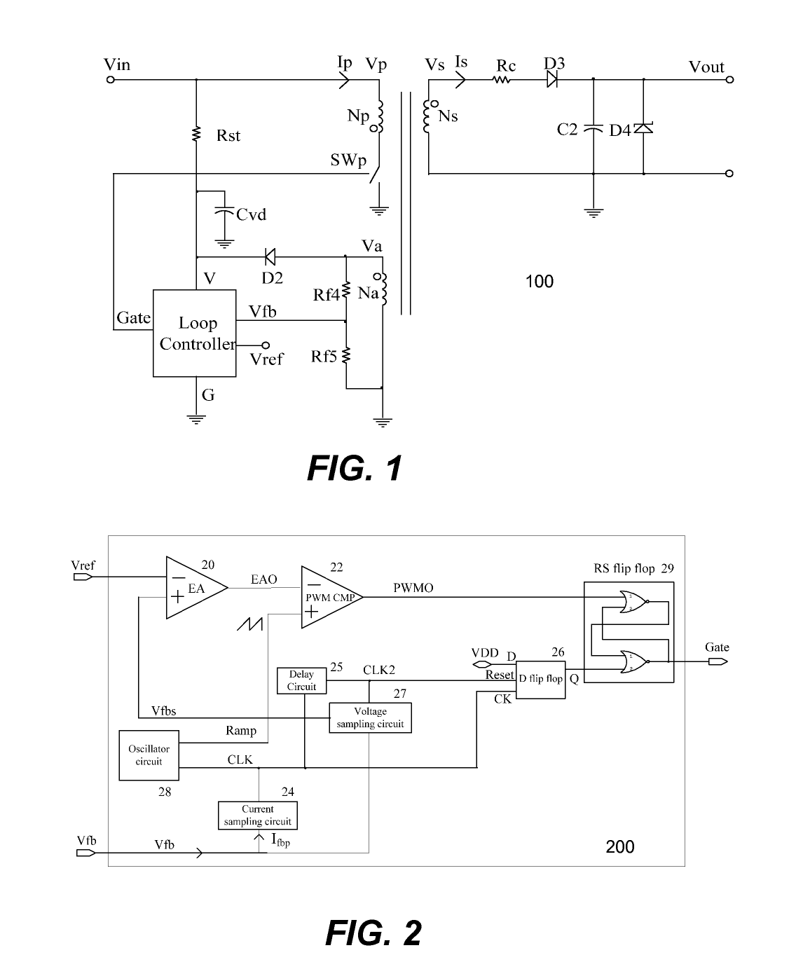

Embodiments of the present invention are discussed herein with reference to FIGS. 1-12. However, those skilled in the art will readily appreciate that the detailed description given herein with respect to these figures is for explanatory purposes only as the invention extends beyond these limited embodiments.

FIG. 1 is a circuit diagram schematically showing an exemplary flyback power converter 100 according to one embodiment of the present invention. The flyback power converter 100 comprises a primary side, a secondary side, an auxiliary side and a loop controller.

The primary side has a primary winding Np of a transformer and a primary switch SWp operable to control energy storage of the primary winding. The secondary side has a secondary winding Ns of the transformer, a parasitic resistor Rc, an output capacitor C2 and a pair of diodes D3 and D4. The auxiliary side has an auxiliary winding Na of the transformer and a pair of resistors Rf4 and Rf5 in series coupling to the auxiliary winding Na in parallel. The loop controller samples a feedback voltage Vfb being proportional to an output voltage Vout outputted from the secondary side and generates a gate signal with a proper duty cycle D which drives the primary switch SWp to switch off or on by comparing the feedback voltage Vfb with a reference voltage Vref. The primary switch SWp switches on the primary winding Np when the gate signal is a high level, and the primary switch SWp switches off the primary winding Np when the gate signal is a low level.

According to characteristics of the transformer, a secondary side voltage Vs and an auxiliary side voltage Va satisfies the equation: Va/Vs=Na/Vs, where Na is turns of the auxiliary winding and Ns is turns of the secondary winding. The secondary side voltage Vs satisfies the equation: Vs=Vout+Is*Rc+V_{D}, where Is is a secondary side current, V_{D} is a voltage drop of the diode D3 and Rc is a resistance value of the resistor Rc. The feedback voltage Vfb satisfies Vfb=Va*Rf5/(RF5+RF4)=Va*K1, where K1 is a proportional coefficient.

According to the volt-second balance principle of the transformer, the output voltage Vout satisfies the equation: Vout=D*Vp*K2, where D is the duty cycle of the gate signal, K2 is a proportional coefficient and Vp is a primary side voltage. It can be seen that the output voltage Vout of the secondary side is increased with increase of the duty cycle D and is decreased with decrease of the duty cycle D.

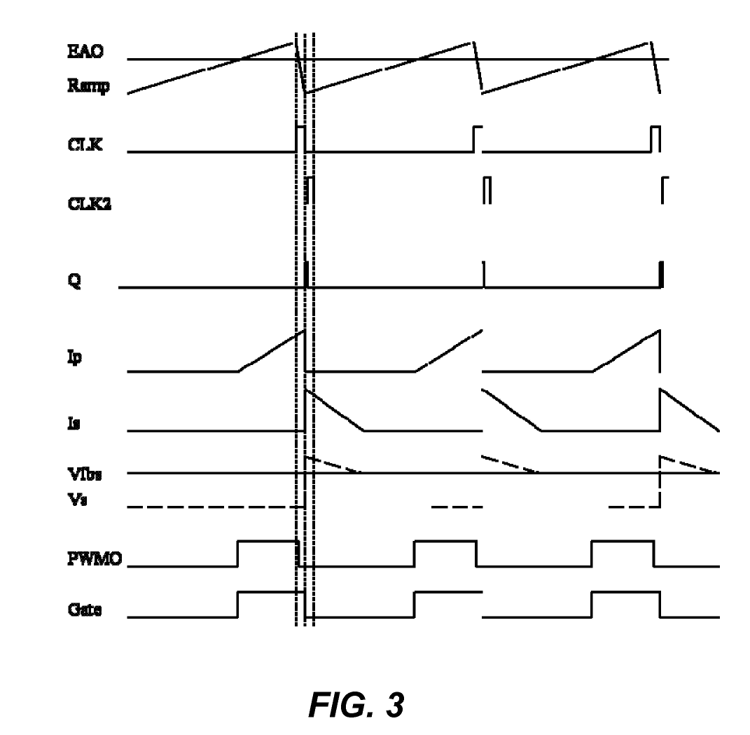

FIG. 2 is a circuit diagram schematically showing an exemplary loop controller 200 that could be used in FIG. 1. The loop controller 200 comprises an error amplifier 20, a pulse width modulation (PWM) comparator 22, a current sampling circuit 24, a delay circuit 25, a D flip flop 26, a voltage sampling circuit 27, an oscillator circuit 28 and a RS flip flop 29. The functional modules of the loop controller are described in detail hereafter with reference to FIG. 2 and FIG. 3.

The oscillator circuit 28 is configured to generate an asymmetric saw-tooth signal RAMP which has a slow slope rising edge and a fast steep falling edge and a clock signal CLK synchronous with the saw-tooth signal RAMP. A high level of the clock signal CLK just corresponds to the fast steep falling edge of the saw-tooth signal. A falling edge of the clock signal CLK is a start point of the slow slope rising edge of the saw-tooth signal RAMP. Hence, the falling edge of the clock signal CLK is fixed.

The current sampling circuit 24 is configured to sample a primary side current Ip on the high level of the clock signal CLK to get a feedback primary current Ifbp. The feedback primary current Ifbp is coupled to a voltage feedback node Vfb as a current sinking source.

The delay circuit 25 is configured to delay the clock signal CLK a period of time such as 20 ns to get a clock signal CLK2. The voltage feedback node Vfb is coupled to an intermediate node of the resistors Rf4 and Rf5. The voltage sampling circuit 27 is configured to sample a voltage of the voltage feedback node Vfb on the high level of the clock signal CLK2 to get a feedback voltage Vfbs.

The feedback voltage Vfbs is coupled to a non-inverting input of the error amplifier 20, and a reference voltage Vref is coupled to an inverting input of the error amplifier 20. The error amplifier 20 is configured to amplify a difference between the reference voltage Vref and the feedback voltage Vfbs to get an error voltage EAO.

The error voltage EAO is coupled to an inverting input of the PWM comparator 22, and the saw-tooth signal RAMP is coupled to a non-inverting input of the PWM comparator 22. The PWM comparator 22 is configured to compare the error voltage EAO and the saw-tooth signal RAMP to get a PWM signal PWMO. The duty cycle of the PWM signal PWMO is adjusted by adjusting a rising edge of the PWM signal PWMO. In other words, the rising edge of the PWM signal PWMO is adjustable, and a falling edge of the PWM signal PWMO is fixed relatively.

The clock signal CLK is coupled to a clock terminal CK of the D flip flop 26, a power supply VDD is coupled to an input terminal of the D flip flop 26, and the clock signal CLK2 is coupled to a reset terminal of the D flip flop 26. An output terminal Q of the D flip flop 26 is coupled to one input of the RS flip flop 29, the PWM signal PWMO is coupled to the other input of the RS flip flop 29, and the RS flip flop 29 outputs the gate signal.

The D flip flop 26 sets the output terminal Q as the high level at the falling edge of the clock signal CLK and resets the output terminal Q as the low level at the rising edge of the clock signal CLK2. When the output terminal Q is the high level, the gate signal is reset as the low level. When the output terminal Q is the low level and the PWM signal PWMO becomes the high level from the low level, the gate signal is set as the high level.

The rising edge of the gate signal is determined by the rising edge of the PWM signal PWMO, and the falling edge of the gate signal is determined by the falling edge of the clock signal CLK. Thus, the rising edge of the gate signal is adjustable because the rising edge of the PWM signal PWMO is adjustable, and the falling edge of the gate signal is fixed because the falling edge of the clock signal CLK is fixed. Hence, the duty cycle of the gate signal is adjusted by adjusting the rising edge of the gate signal.

In operation, the feedback primary current Ifbp is sampled before the primary switch SWp is switched off, and the feedback voltage Vfbs is sampled after the primary switch SWp is switched off. The sampled feedback voltage Vfbs is updated to generate a new duty cycle D of the gate signal after the primary switch SWp is switched off each time. The new duty cycle of the gate signal is used to determine the rising edge of the gate signal in this cycle. In other words, the new duty cycle generated in the current cycle becomes effective in the current cycle. Thereby, the delay to update the duty cycle may be half of cycle or less than half of cycle in the present invention. The duty cycle of the gate signal is adjusted constantly by adjusting the rising edge of the gate signal until the feedback voltage Vfbs is equal to the reference voltage Vref.

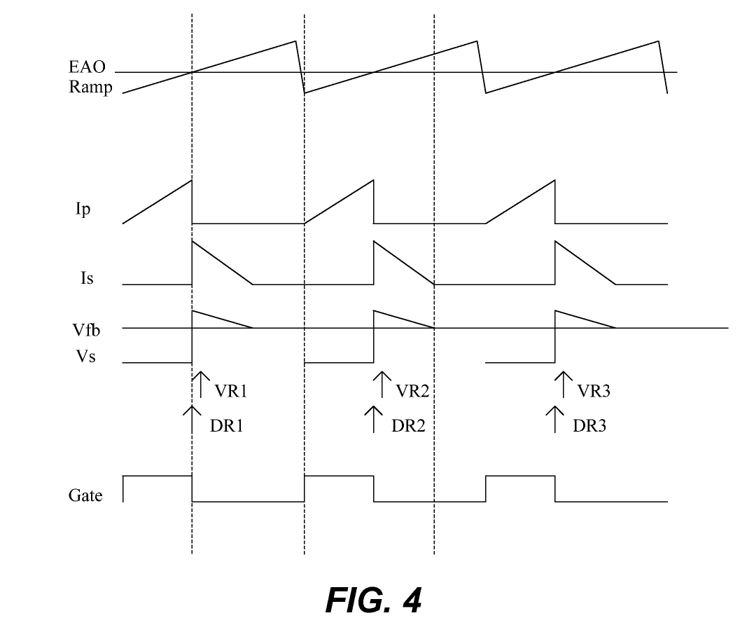

Referring to FIG. 4, which schematically shows waveforms of signals of a conventional flyback power converter, the rising edge of the gate signal is fixed and the falling edge of the gate signal is adjustable. Hence, the duty cycle of the gate signal is adjusted by adjusting the rising edge of the gate signal in the prior art. Sampling times of the feedback voltage are shown in FIG. 4 such as VR1, VR2 and VR3. Updating times of the duty cycle are shown in FIG. 4 such as DR1, DR2 and DR3. As shown in FIG. 4, it requires almost one cycle delay to update the duty cycle in the prior art.

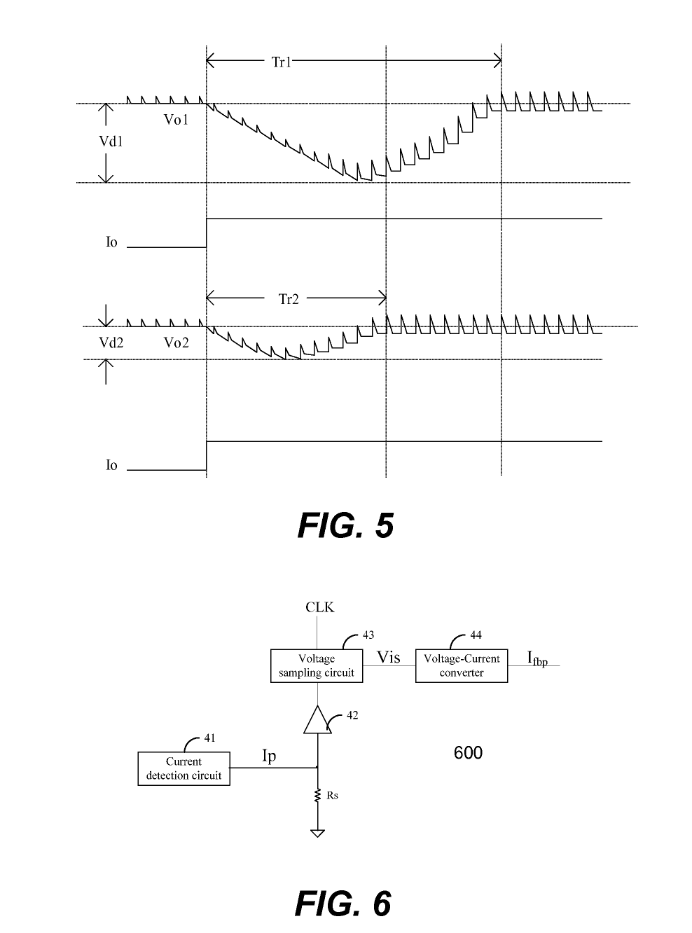

FIG. 5 is a schematic comparison diagram of a loop transient response of the conventional flyback power converter and a loop transient response of the flyback power converter in the present invention. Referring to FIG. 5, Vo1 is an output voltage of the conventional flyback power converter, Tr1 is a response time to recover a steady state for the conventional flyback power converter, Td1 is an undershoot voltage of the output voltage of the conventional flyback power converter, Vo2 is an output voltage of the flyback power converter in the present invention, Tr2 is a response time to recover a steady state for the flyback power converter in the present invention, Td2 is an undershoot voltage of the output voltage of the flyback power converter in the present invention. It can be seen that the flyback power converter in the present invention has the shorter response time and the smaller undershoot voltage.

In a preferred embodiment, the reference voltage Vref may be a reference voltage based on a band-gap voltage reference source.

Next, specific implementations of various functional modules are described hereafter.

FIG. 6 is a block diagram shows an exemplary current sampling circuit according to one embodiment of the present invention. The current sampling circuit comprises a current detection circuit 41, a buffer 42, a voltage sampling circuit 43 and a voltage-current converter 44. The current detection circuit 41 detects the primary side current Ip. The buffer 42 buffers the primary side current Ip. The voltage sampling circuit 43 samples the primary side current Ip on the high level of the clock signal CLK. The voltage-current converter 44 converts the sampled voltage into the feedback primary current.

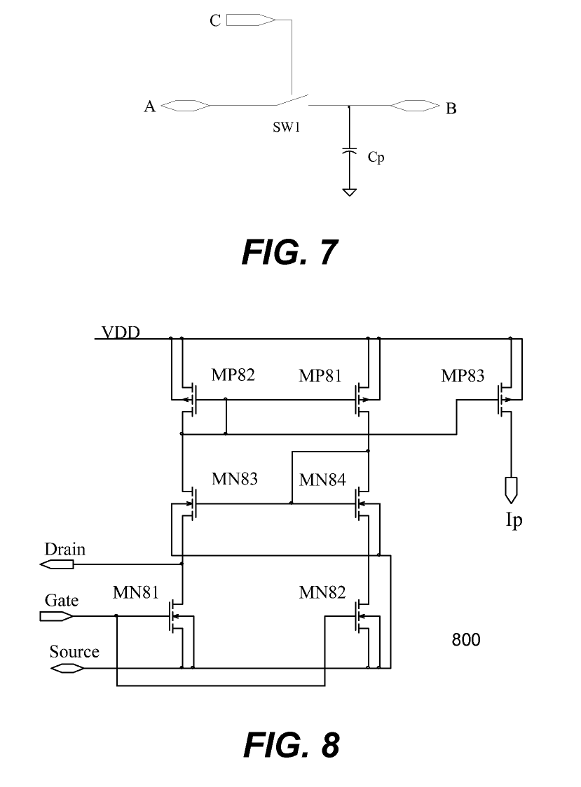

FIG. 7 shows an exemplary configuration of the voltage sampling circuit 27 or 43. The voltage sampling circuit comprises a switch SW1 and a capacitor Cp. A control terminal C of the switch circuit SW1 is coupled to the clock signal CLK or CLK2. The capacitor Cp is charged when the switch circuit SW1 switches on. The charged voltage of the capacitor Cp is used as the sampled voltage. The switch circuit SW1 may be a NMOS transistor or a PMOS transistor.

FIG. 8 is a circuit diagram showing an exemplary current detection circuit shown in FIG. 6. The current detection circuit comprises PMOS transistors MP81, MP82 and MP83, and NMOS transistors MN81, MN82, MN83 and MN84. The NMOS transistors MN81 and MN82 form a current mirror, the NMOS transistors MN83 and MN84 form a current mirror, and the PMOS transistors MP81, MP82 and MP83 form a current mirror. The NMOS transistors MN81 and MN83 and the PMOS transistor MP82 are connected in series. The NMOS transistors MN82 and MN84 and the PMOS transistor MP81 are connected in series. The primary switch is a NMOS transistor in this embodiment. The primary switch is connected with the NMOS transistor MN1 in parallel. A drain of the PMOS transistor MP83 is used as an output terminal of the current detection circuit.

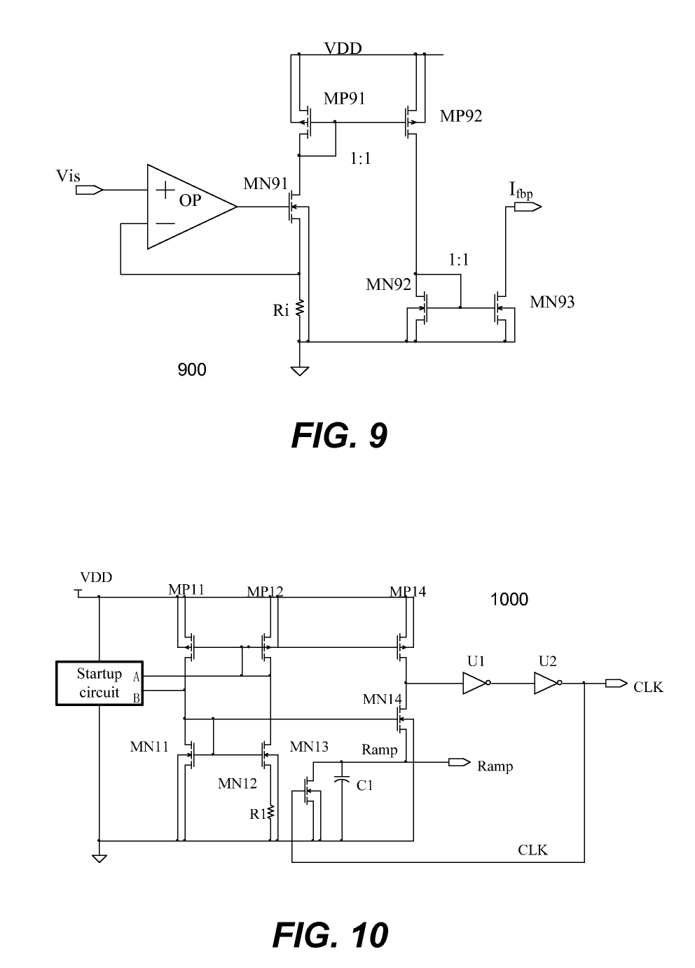

FIG. 9 is a circuit diagram showing an exemplary voltage-current converter shown in FIG. 6. The voltage-current converter comprises an operational amplifier OP, NMOS transistors MN91, MN92 and MN93, PMOS transistors MP91 and MP92, and a resistor Ri. The NMOS transistors MN91, MN92 and MN93 form a current mirror. The PMOS transistors MP91 and MP92 form a current mirror. The NMOS transistor MN91, the PMOS transistor MP91 and the resistor Ri are connected in series. The NMOS transistor MN92 and the PMOS transistor MP92 are connected in series. The sampled voltage Vis is coupled to a non-inversing input of the operational amplifier OP. An inverse input of the operational amplifier is coupled to an intermediate node between the NMOS transistor MN91 and the resistor Ri. An output of the operational amplifier is coupled to a gate of the NMOS transistor MN91. A drain of the NMOS transistor MN93 output the feedback primary current.

FIG. 10 is a circuit diagram showing an exemplary oscillator circuit. The oscillator circuit comprises a startup circuit, PMOS transistor MP11, MP12 and MP14, NMOS transistor MN11, MN12, MN13 and MN14, a capacitor C1, and a pair of inverters U1 and U2. The PMOS transistors MP11, MP12 and MP14 form a current mirror. The NMOS transistors MN11 and MN12 form a current mirror. The NMOS transistor MN11 and the PMOS transistor MP11 are connected in series. The NMOS transistor MN12 and the PMOS transistor MP12 are connected in series. The NMOS transistor MN14 and the PMOS transistor MP14 are connected in series. A gate of the NMOS transistor MN14 is coupled to a gate of the NMOS transistor MN11. A drain of the NMOS transistor MN14 is coupled to one terminal of the capacitor C1. The other terminal of the capacitor C1 is coupled to the ground. The inverters U1 and U2 are connected in series. An input terminal of the inverter U1 is coupled to an intermediate node between the PMOS transistor MP14 and the NMOS transistor MN14, and an output terminal of the inverter U2 outputs the clock signal CLK. The NMOS transistor MN13 is connected with the capacitor C1 in parallel. A gate of the NMOS transistor MN13 is coupled to the output of the terminal of the inverter U2. One terminal of the startup circuit is coupled to a gate of the PMOS transistor MP11, and the other terminal of the startup circuit is coupled to a drain of the PMOS transistor MP11.

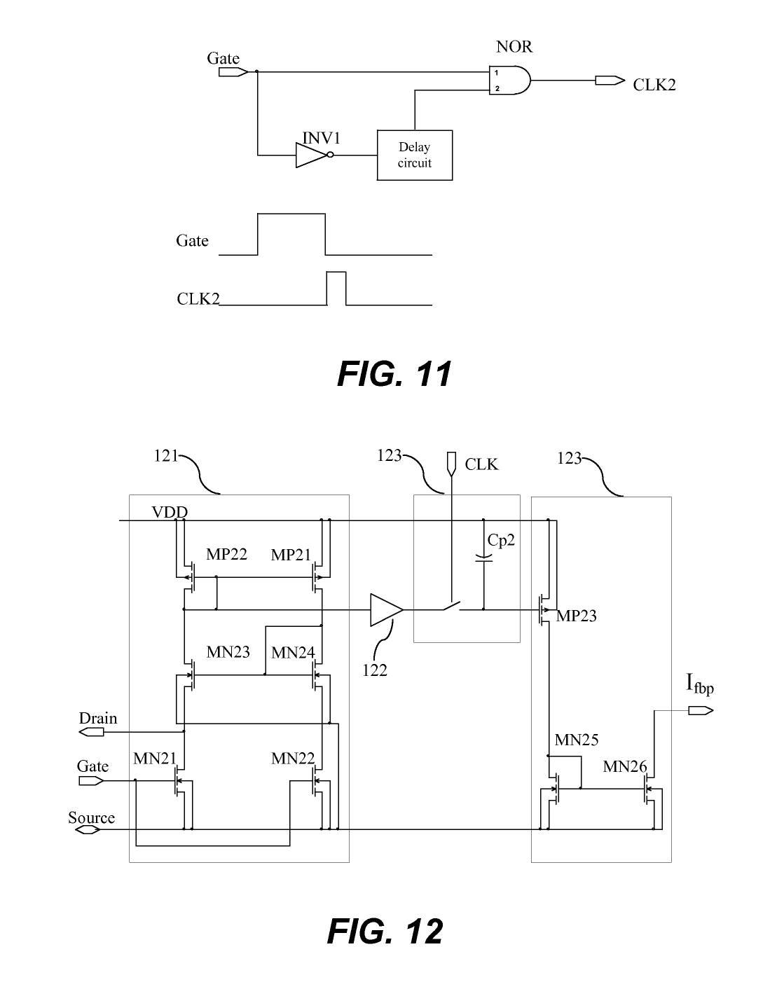

FIG. 11 is a circuit diagram showing another exemplary circuit generating a second clock signal CLK2. The circuit comprises a NOR gate, a delay circuit and an inverter INV1. The gate signal is coupled to one input of the NOR gate and an input of the inverter INV1. An output terminal of the inverter INV1 is coupled to the delay circuit. An output terminal of the delay circuit is coupled to the other input of the NOR gate. The NOR gate outputs the second clock signal CLK2. a duty cycle of the second clock signal CLK2 is determined by the delay circuit.

FIG. 12 is a circuit diagram showing another exemplary current sampling circuit. The current sampling circuit comprises a current detection circuit 121, a buffer 122, a voltage sampling circuit 123 and a voltage-current circuit 124. The specific circuit structures are omitted herein for simplicity.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A power converter, comprising:
a primary side comprising a primary winding of a transformer coupled to an input voltage and a primary switch for switching on or off the primary winding;
a secondary side comprising a secondary winding of the transformer for generating an output voltage; and
a loop controller configured for sampling a feedback voltage representative of the output voltage, generating a gate signal with a fixed falling edge and an adjustable rising edge to drive the primary switch, and adjusting a duty cycle of the gate signal by adjusting the rising edge of the gate signal until the feedback voltage converges to a reference voltage.

2. The power converter according to claim 1, wherein the loop controller comprises:
an oscillator circuit for generating an asymmetric saw-tooth signal having a slow slope edge and a fast steep edge, and wherein
the falling edge of the gate signal corresponds to a start point of the slow slope edge.

3. The power converter according to claim 2, wherein the loop controller comprises:
an error amplifier configured for amplifying a difference between the reference voltage and the feedback voltage to get an error signal; and
a PWM comparator configured for comparing the error signal with the saw-tooth signal to get a PWM signal; and wherein the rising edge of the gate signal corresponds to an adjustable rising edge of the PWM signal.

4. The power converter according to claim 3, wherein the oscillator circuit further generates a clock signal synchronous with the asymmetric saw-tooth signal, a high level of the clock signal corresponds to the fast steep edge of the asymmetric saw-tooth signal, and the falling edge of the gate signal is determined according to the falling edge of the clock signal.

5. The power converter according to claim 4, wherein the loop controller comprises:
a delay circuit configured for delaying the clock signal a period of time to get a second clock signal;
a current sampling circuit configured for sampling a primary side current on the high level of the clock signal to get a feedback primary current coupled to a feedback voltage node as a current sinking source; and
a voltage sampling circuit configured for sampling a voltage at the feedback voltage node on the high level of the second clock signal to get the feedback voltage.

6. The power converter according to claim 5, further comprising:
an auxiliary side comprising an auxiliary winding of the transformer and a pair of resistors and in series coupling to the auxiliary winding in parallel; and wherein an intermediate node is used as the feedback voltage node.

7. The power converter according to claim 5, wherein the loop controller comprises:
a D flip flop having an input terminal coupled to a high level, a reset terminal coupled to the second clock signal, a clock terminal coupled to the clock signal and an output terminal; and
a RS flip flop having a first input terminal coupled to the output terminal of the D flip flop, a second input terminal coupled to the PWM signal and an output terminal outputting the gating signal.

8. A controller for a power converter, comprising:
a voltage feedback circuit for providing a feedback voltage representative of an output voltage of the power converter;
an oscillator circuit for generating an asymmetric saw-tooth signal having a slow slope edge and a fast steep edge and a clock signal synchronous with the asymmetric saw-tooth signal;
an error amplifier configured for amplifying a difference between a reference voltage and the feedback voltage to get an error signal;
a PWM comparator configured for comparing the error signal with the saw-tooth signal to get a PWM signal having an adjustable rising edge; and
a control logic circuit configured for generating a gate signal having a fixed falling edge determined by a falling edge of the clock signal and an adjustable rising edge determined by the rising edge of the PWM signal.

9. The controller according to claim 8, wherein the falling edge of the clock signal corresponds to a start point of the slow slope edge of the asymmetric saw-tooth signal.

10. The controller according to claim 8, further comprising:
a delay circuit configured for delaying the clock signal a period of time to get a second clock signal; and wherein the voltage feedback circuit comprises:
a current sampling circuit configured for sampling a primary side current on a high level of the clock signal to get a feedback primary current coupled to a feedback voltage node as a current sinking source; and
a voltage sampling circuit configured for sampling a voltage at the feedback voltage node on the high level of the second clock signal to get the feedback voltage.

11. The controller according to claim 10, wherein the control logic circuit comprises:
a D flip flop having an input terminal coupled to a high level, a reset terminal coupled to the second clock signal, a clock terminal coupled to the clock signal and an output terminal; and
a RS flip flop having a first input terminal coupled to the output terminal of the D flip flop, a second input terminal coupled to the PWM signal and an output terminal outputting the gating signal.
